(19) United States
(12) Patent Application Publication
(10) Pub. No.: US 2005/0107056 A1
(43) Pub. Date: May 19, 2005

(54) Communication semiconductor integrated circuit device and a wireless communication system

(76) Inventors: Akira Okasaka, Kodaira (JP); Koichi Yahagi, Kodaira (JP); Masakazu Sakagami, Kodaira (JP); Robert Astle Henshaw, Royston (GB)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 10/495,628

(22) PCT Filed: Nov. 13, 2002
(86) PCT No.: PCT/GB02/05126

(30) Foreign Application Priority Data
Nov. 16, 2001 (GB) 0127535.3

(51) Int. Cl. H04B 1/06; H04B 7/00

(52) U.S. Cl. 455/251.1; 455/252.1

(57) ABSTRACT

A communication semiconductor integrated circuit device (200) includes an amplifier circuit (330) including a plurality of variable-gain amplifiers (PGA1-PGA3) for amplifying a received signal and a plurality of filter circuits (LPF1-LPF3), the amplifiers and the filter circuits being connected to each other in a multi-stage configuration, and a last amplifier (FFGA) having a gain set regardless of a level of a received signal and a filter circuit, the last amplifier and the filter circuit are disposed at the last stage of the amplifier circuit. The amplifier circuit has an amplification factor variable according to a level of a received signal. The communication semiconductor integrated circuit device further includes a plurality of offset correction circuits (OFC1-OFC4) for correcting direct-current offset, corresponding to the variable-gain amplifiers and the last amplifiers, respectively. The offset correction circuit (OFC4) corresponding to the last amplifier conducts an offset correction at a timing different from timing for the other offset correction circuits (OFC1-OFC3).

The present invention relates to a technique efficiently applicable to a variable-gain signal amplifier circuit and an amplifier circuit in a wireless communication apparatus to amplify a signal received by the apparatus, and to a technique efficiently usable for a programmable gain amplifier constituting a wireless communication system having a transmission/reception mode, e.g., an Enhanced Data Rates for global system for mobile communications (GSM) Evolution (EDGE) mode.

As shown in FIG. 1, a portable telephone includes, to amplify a received signal while removing noise and a signal of an unnecessary frequency, a circuit in which a combination of a low-pass filter LPF and a programmable gain amplifier PGA (to be abbreviated as PGA hereinbelow) are disposed in a multi-stage configuration including several stages. In an analog amplifier circuit such as a PGA, a direct-current offset occurs, for example, by fluctuation in characteristics of constituent components of the amplifier circuit. This inevitably requires offset cancel.

Heretofore, in a signal receiving circuit of a portable telephone including several programmable gain amplifiers (PGA), an offset correction or correcting circuit is disposed for each PGA in general. In a portable telephone of GSM, a transmission mode and a reception mode are repeatedly changed to each other according to a unit of time called “slot”, for example, at an interval of time of 577 microseconds (μs) as shown in FIG. 8. The offset correction circuit is configured to conduct the offset cancel of all programmable gain amplifiers (PGA) during a short period of time, e.g., 20 μs allowed for or available in the slot change time as shown in FIG. 2A.

On the other hand, the wireless communication apparatuses represented by a portable telephone today are increasingly operated in a digital communication system. In the digital communication, signals are modulated in various ways such as the frequency modulation, the phase modulation, and the time division multiplex modulation. There also exists a communication apparatus employing a dual mode including, for example, the Gaussian minimum shift keying (GMSK) modulation and the EDGE modulation. That is, the GMSK modulation is used for audio signal communication in which a waveform of a transmission signal is first shaped by a filter of Gauss type and then a phase of a carrier wave is shifted according to transmission data, and the EDGE modulation is used to communicate data at a high speed in which an amplitude shift operation is conducted in addition to the phase shift of the GMSK modulation.

The EDGE modulation is also called GSM 348 or UWC-136 and uses the Time Division Multiple Access (TDMA) in the wireless communication. The EDGE modulation has a maximum data communication speed of 384 kilobytes per second (Kbps) and hence is suitable for applications such as a video conference and a remote medical treatment.

In an amplifier circuit including low-pass filters and programmable gain amplifiers in the signal receiving circuit of a portable telephone of EDGE system, an amplitude modulation is conducted for a high-frequency signal and hence a signal level becomes higher by about 3 decibel (dB) to about 3.5 dB than a mean amplitude level of GSM for the maximum amplitude as shown in FIG. 9. The signal is received as a disturbing (interference) wave. When the disturbing wave is larger in the signal level than a desired wave as shown in FIG. 10, the gain of the amplifier is clipped by the disturbing wave and hence the dynamic range of the amplifier circuit is determined. Therefore, the desired wave cannot be fully amplified.

In the receiving circuit of a portable telephone of EDGE system, the characteristic of the low-pass filter must be set as shown in FIG. 11 such that the receiving circuit attenuates an increased amount of high-frequency disturbing waves than the receiving circuit of a portable telephone of the prior art not using the amplitude modulation. To increase the amount of high-frequency disturbing waves without changing the passing band, it is necessary to increase the order of the low-pass filter. However, since a high-gain PGA exists in a stage following each low-pass filter, when the order of the low-pass filter is increased, the noise figure (NF), i.e., a ratio between a signal-to-noise ratio of an input signal and that of an output signal is deteriorated. To almost completely remove the disturbing waves by the low-pass filter LPF1 in the first stage, the value of a resistor of the low-pass filter must be increased. However, such a large value of the resistor increases thermal noise caused by the resistor, and the noise figure is resultantly deteriorated.

Preferably, to remove the disadvantage, the inventors examined a configuration in which an amplifier PGA4 (FFGA) having a fixed gain and a low-pass filter LPF4 are arranged after the PGA3 of the last stage as shown in FIG. 3. As a result, it has been recognized that although the arrangement of the low-pass filter at the preceding stage of the fixed-gain amplifier is advantageous for the noise figure, a satisfactory dynamic range cannot be obtained because of restriction of the power source voltage. Moreover, when the fixed-gain amplifier is arranged, the offset thereof must be canceled. In this situation, if there exists only the fixed-gain amplifier, the offset cancel operation can be completely finished within the predetermined period, i.e., 20 μs by conducting the offset cancel operation for the amplifiers including the last-stage PGA at a time according to an output from the fixed-gain amplifier. However, when there exists the low-pass filter, if the offset cancel operation is conducted by the offset correcting circuit OFC 3 at a time, it is difficult because of influence from the time constant of the low-pass filter to completely achieve the offset cancel operation within the predetermined period, i.e., 20 as shown in FIG. 2B.

It has been recognized that in consideration of general uses of a high-frequency semiconductor integrated circuit (to be referred to as a high-frequency LSI hereinbelow) to conduct amplification and demodulation of a received signal in a portable telephone, the fixed-gain amplifier after the last-stage PGA favorably has a variable gain even in the high-frequency LSI of EDGE system.

Preferably it is therefore an object of the present invention to provide a high-frequency LSI including an amplifier circuit capable of completely finishing the offset cancel operation within a predetermined period of time even when a fixed-gain amplifier and a low-pass filter are arranged in a last stage to amplify a received signal associated with amplitude modulation such as amplitude modulation of EDGE system.

Preferably another object of the present invention is to provide a high-frequency LSI including an amplifier circuit having a satisfactory noise figure and a necessary dynamic range.

Preferably still another object of the present invention is to provide a high-frequency LSI for general uses which can cope with a plurality of wireless communication systems.

The above and other objects and novel features of the present invention will become more apparent from the consideration of the following detailed description taken in conjunction with the accompanying drawings.

Representative aspects of the present invention disclosed by this application will be described below.

According to a first aspect of the present invention, there is provided a communication semiconductor integrated circuit device comprising an amplifier circuit comprising a plurality of variable-gain amplifiers for amplifying a received signal and a plurality of filter circuits for removing noise and unnecessary waves, said amplifiers and said filter circuits being connected to each other in a multi-stage configuration. The amplifier circuit has an amplification factor variable according to a level of a received signal. The amplifier circuit comprises in a last stage thereof a last amplifier having a gain set regardless of a level of a received signal and a filter circuit. According to the first aspect, the amount of attenuated waves increases in a high-frequency band without changing the passing band, and the noise figure is improved when compared with a case in which the filter circuit is arranged in a stage preceding the variable-gain amplifier.

It is favorable that the last amplifier is an amplifier of which the gain can be changed. The filter circuit is arranged in a stage preceding the last amplifier. By using an amplifier of which the gain can be changed as the last amplifier, an optimal gain can be selected according to a type of the baseband circuit connected to the high-frequency semiconductor circuit. This expands the general usability of the high-frequency semiconductor circuit. By arranging the filter circuit in a stage preceding the last amplifier, a satisfactory dynamic range can be obtained.

According to a second aspect of the present invention, there is provided a communication semiconductor integrated circuit device, comprising an amplifier circuit comprising a plurality of variable-gain amplifiers for amplifying a received signal and a plurality of filter circuits, said amplifiers and said filter circuits being connected to each other in a multi-stage configuration; and a last amplifier having a gain set regardless of a level of a received signal and a filter circuit, said last amplifier and said filter circuit being disposed in a last stage of said amplifier circuit, said amplifier circuit having an amplification factor variable according to a level of a received signal. The communication semiconductor integrated circuit device further comprising a plurality of offset correction circuits for correcting direct-current offset corresponding to said variable-gain amplifiers and said last amplifiers. The offset correction circuit corresponding to said last amplifier conducts an offset correction operation at timing different from timing of other said offset correction circuits.

The different offset timing can be implemented in a method as follows. For example, the offset correction by an offset correction circuit corresponding to the variable-gain amplifier is conducted when a predetermined unit of time called “slot” is changed. The offset correction by an offset correction circuit corresponding to the last amplifier is conducted in an operation state such as a warm-up mode disposed to activate and to stabilize operation of an oscillator or oscillation circuit.

According to the second aspect, even when a fixed-gain amplifier and a low-pass filter are arranged in a last stage to amplify a received signal associated with amplitude modulation such as EDGE modulation, the offset cancel operation can be completely finished within a predetermined period of time using an offset correction circuit of the prior art. By conducting the offset correction in association with an operation state such as a warm-up mode, timing of operation of the offset correction circuit can be easily determined according to the setting of the control register originally arranged in the system.

### BRIEF DESCRIPTION OF THE DRAWINGS

FIG. 1 is a block diagram showing an example of constitution of a PGA circuit block in a high-frequency LSI of the prior art;

FIG. 2A is a timing chart showing offset correction timing of a PGA circuit block of the prior art;

FIG. 2B is a timing chart of a PGA circuit block discussed in a process of the present invention;

FIG. 3 is a block diagram showing an example of constitution of a PGA circuit discussed in a process of the present invention;

FIG. 4 is a block diagram showing a configuration example of a portable telephone as an example of a wireless communication system according to the present invention;

FIG. 5 is a block diagram showing an embodiment of a PGA circuit block according to the present invention;

FIG. 6 is a block diagram showing another embodiment of a PGA circuit block according to the present invention;

FIG. 7 is an explanatory diagram showing transitions between modes in a wireless communication system to which the present invention is efficiently applicable;

FIG. 8 is an explanatory diagram showing an example of a time slot in a GSM wireless communication system to which the present invention is efficiently applicable;

FIG. 9 is a waveform graph showing a signal wave in a GSM wireless communication system and a signal wave in an EDGE wireless communication system;

FIG. 10 is a graph for explaining an example of frequency distribution of a desired wave and disturbing waves in an EDGE wireless communication system; and

FIG. 11 is a graph showing a frequency characteristic of a filter required in a wireless communication system of the prior art and a frequency characteristic of a filter required in an EDGE wireless communication system.

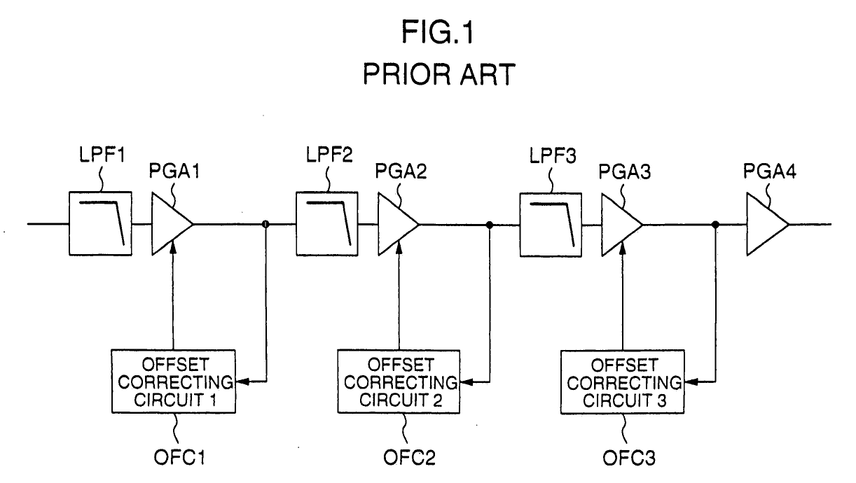

### DESCRIPTION OF THE EMBODIMENTS

Next, description will be given of an embodiment of the present invention by referring to the drawings.

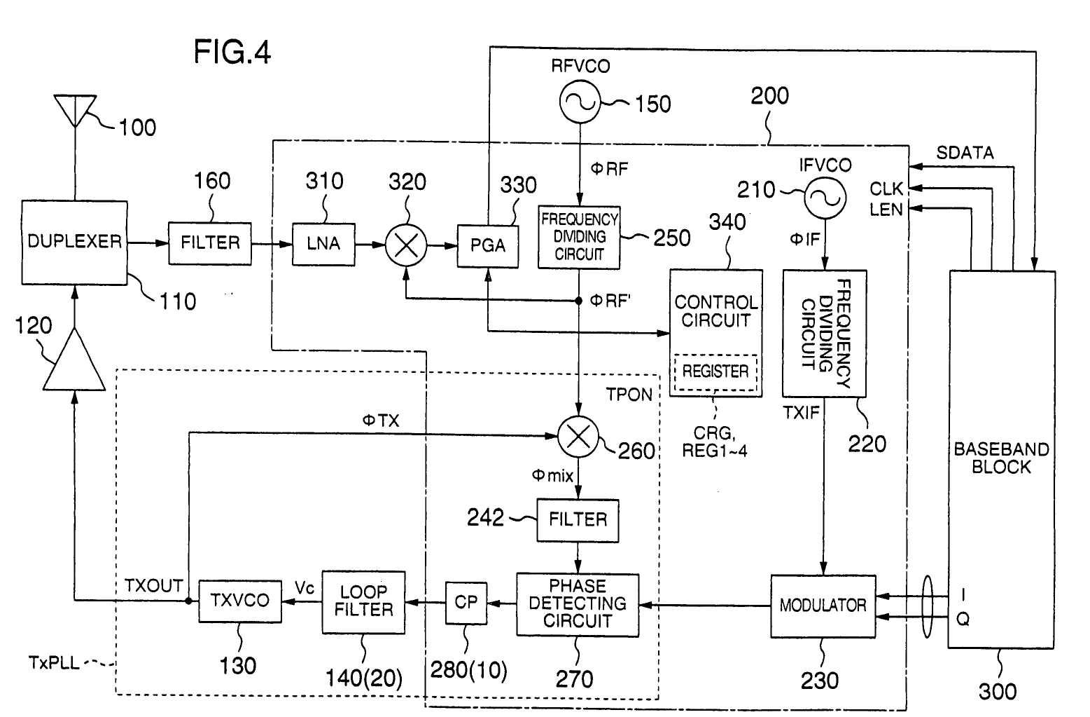

FIG. 4 shows, as an example of a system to which the present invention is suitably applicable, an example of detailed constitution of a high-frequency LSI and an overall general configuration of a communication apparatus in a mobile communication system for EDGE. Although not particularly limited to, the system of this embodiment is called a direct conversion system.

The configuration of FIG. 4 includes a signal wave transmitting and receiving antenna 100, a high-frequency LSI 200, a transmission/reception switching device 110, a high-frequency power amplifier circuit 120 to amplify a transmission signal, a transmission oscillator (TXVCO) 130, a loop filter 140 constituting a transmission phase-locked loop (PLL) circuit, a high-frequency oscillator (RFVCO) 150 to generate an oscillation signal with a frequency corresponding to a desired band, a high-frequency filter 160 to remove undesired waves from a received signal, and a baseband circuit (LSI) 300 which extracts data from a received signal down-converted by the high-frequency LSI 200 to a desired frequency, which converts transmission data into I and Q signals, and which controls the high-frequency LSI 200. Although not particularly limited to, the high-frequency oscillator (RFVCO) 150 of this embodiment is shared between the circuits on the transmission section and the circuits on the reception section.

The high-frequency LSI 200 includes a transmission circuit system including an oscillator circuit (IFVCO) 210 to generate an oscillation signal φ IF of an intermediate frequency Frf, e.g., 320 megaherz (MHz), a frequency dividing circuit 220 which divides the oscillation signal φ IF generated by the oscillator circuit 210 to generate a carrier wave of 80 MHz, a modulator circuit 230 to directly modulate the carrier wave from the frequency dividing circuit 220 using the I and Q signals from the baseband circuit 300, a frequency dividing circuit 250 to divide an oscillation signal φ RF from the high-frequency oscillator 150, a mixer 260 to mix a signal φ RF′ divided by the frequency dividing circuit 250 with a transmission signal φ TX fed back from the transmission oscillator (TXVCO) 130 so as to generate a signal φ mix of a frequency equivalent to a frequency difference between these signals, a harmonic filter 242 to remove a high-frequency component as a leakage signal from the mixer 260, a phase detector circuit 270 to detect a phase difference between the signal from the mixer 260 and the modulated signal from the modulator circuit 230, and a charge pump 280 to conduct operation in response to a signal such as UP or DOWN from the phase detector circuit 270.

The high-frequency LSI 200 includes a reception circuit system including a low-noise amplifier 310 to amplify a received signal, a demodulator circuit 320 to conduct signal demodulation by mixing the received signal with a signal produced from the frequency dividing circuit 250 by dividing the oscillation signal φ RF from the high-frequency oscillator 150, a PGA circuit block 330 which amplifies and outputs the demodulated signal to a baseband circuit 300, and a control circuit 340 which controls the gain of the PGA circuit block 330 and which cancels the offset thereof. The control circuit 340 includes a control register CRG. The register CRG is set according to a signal from the baseband circuit 300. The control circuit 340 conducts a control operation according to the control data.

Specifically, the baseband circuit 300 is supplying a synchronizing clock signal CLK, a data signal SDATA, and a load enable signal LEN as a control signal to the high-frequency LSI 200. When the load enable signal LEN is asserted to be at an effective level, the control circuit 330 sequentially acquires the data signal SDATA from the baseband circuit 300 at timing synchronized with the clock signal CLK and sets the data to the control register CRG, and then starts a predetermined control sequence. Although not particularly limited to, the data signal SDATA is serially transmitted.

Although not shown in FIG. 4, the demodulator circuit 320 includes a mixer to mix the received signal with a sine wave signal and a mixer to mix the received signal with a cosine wave signal, and two PGA circuit blocks 330 are arranged corresponding to the respective mixers. The signals are demodulated as an I signal and a Q signal and are supplied to the baseband circuit 300.

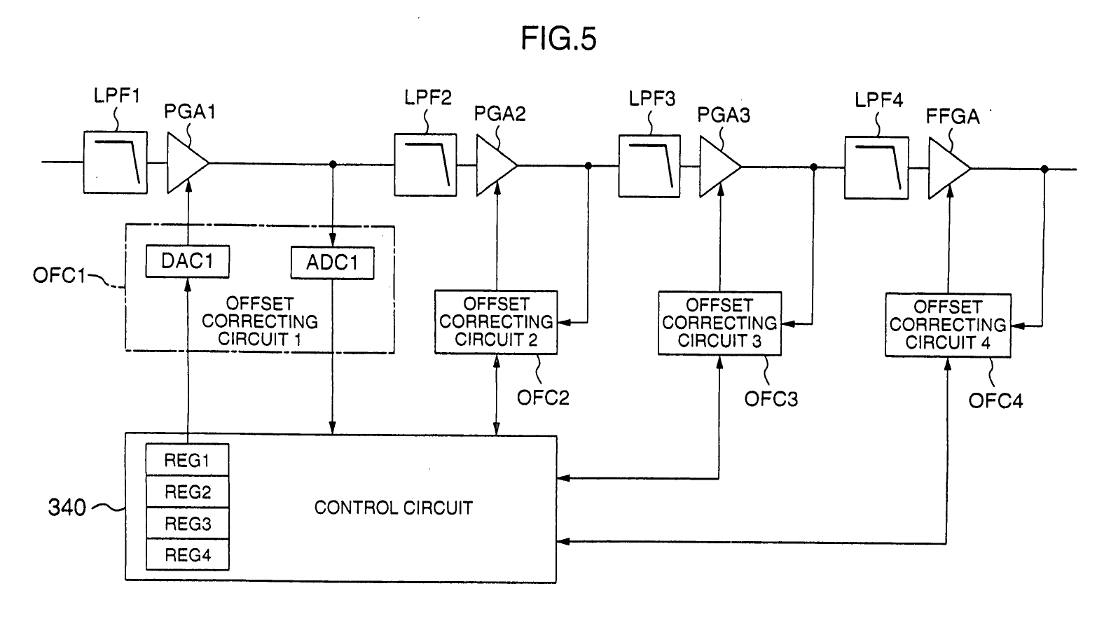

FIG. 5 shows an embodiment of the PGA circuit block 330.

In this embodiment, a first programmable gain amplifier PGA1 is disposed in a stage following a first low-pass filter LPF1, a second low-pass filter LPF2 is disposed in a stage following the first programmable gain amplifier PGA1, and a second programmable gain amplifier PGA2 is disposed in a stage following the second low-pass filter LPF2. Moreover, a third low-pass filter LPF3 is disposed in a stage following the second programmable gain amplifier PGA2, and a third programmable gain amplifier PGA3 is disposed in a stage following the third low-pass filter LPF3. Additionally, a fourth low-pass filter LPF4 is disposed in a stage following the third programmable gain amplifier PGA3, and a last amplifier FFGA having about four changeable gains is disposed in a stage following the fourth low-pass filter LPF4. The programmable gain amplifiers PGA1 to PGA3 can adjust the gain in a linear way or in more stages than the last amplifier FFGA.

The gain of the last amplifier FFGA is uniquely determined according to the system when the type of the baseband circuit is determined in the system. Therefore, a fixed-gain amplifier can also be employed as the last amplifier FFGA. However, in this embodiment, by using an amplifier which can change the gain in about four stages, general usability of the high-frequency LSI 200 is expanded.

In the high-frequency LSI 200, a first offset correction circuit OFC1 is disposed for the first programmable gain amplifier PGA1, a second offset correction circuit OFC2 is disposed for the second programmable gain amplifier PGA2, a third offset correction circuit OFC3 is disposed for the third programmable gain amplifier PGA3, and a fourth offset correction circuit OFC4 is disposed for the last amplifier FFGA.

The offset correction circuits OCF1 to OCF4 will be described. As representatively shown for the offset correction circuit OFC1 in the drawings, the circuit OFC1 includes an AD converter circuit ADC1 to conduct an analog-to-digital (AD) conversion for an output signal from the amplifier PGA1 and a digital-to-analog (DA) converter circuit DAC1 which conducts a DA conversion for a value held by a register REG1 in the control circuit 340 to adjust a current value of a current flowing through the current source of the amplifier PGA1 to thereby correct the offset value. Each controller 340 includes registers REG1 to REG4 to hold offset correction values respectively corresponding to the offset correction circuits OFC1 to OFC4. To determine the correction values, the input ports respectively of the amplifiers are short-circuited to each other. Signal level differences between signals outputted from the respective amplifiers (offset voltages) are converted into digital values. According to the obtained digital values, the correction values are determined to set each signal level difference (offset voltage) to zero. The resultant correction values are held in the associated registers. The control circuit 340 further includes a register to hold data specifying a gain of a programmable gain amplifier, the data being sent from the baseband circuit 300.

In the PGA circuit block 330 of the embodiment, during a period of 20 μs allowed for the operation to change a slot to another slot, the offset correction circuits OFC1 to OFC3 conduct the offset cancel operations for the programmable gain amplifiers PGA1 to PGA3. During a warm-up mode, the offset correction circuit OFC4 conducts the offset cancel of the last amplifier FFGA. Since the gain of the programmable gain amplifiers PGA1 to PGA3 changes according to a level (intensity) of the received signal, the offset cancel must be conducted for each received signal. However, the gain of the last amplifier FFGA is fixed when the base band circuit to receive an output from the last amplifier FFGA is determined. Therefore, only one offset cancel operation is required for the last amplifier FFGA. That is, the offset cancel of the last amplifier FFGA may be conducted in an initial setting operation during the system setup phase. However, the offset cancel of the last amplifier FFGA is conducted during the warm-up mode for the following reason. Even when properties of matter are changed by a change in the temperature, the offset cancel can be appropriately conducted for the final amplifier FEGA in association with the change of properties of matter.

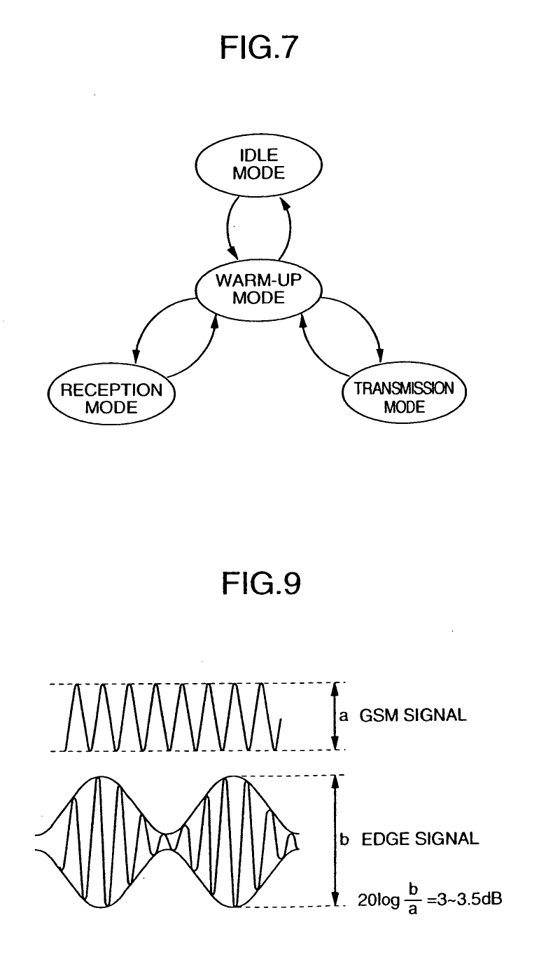

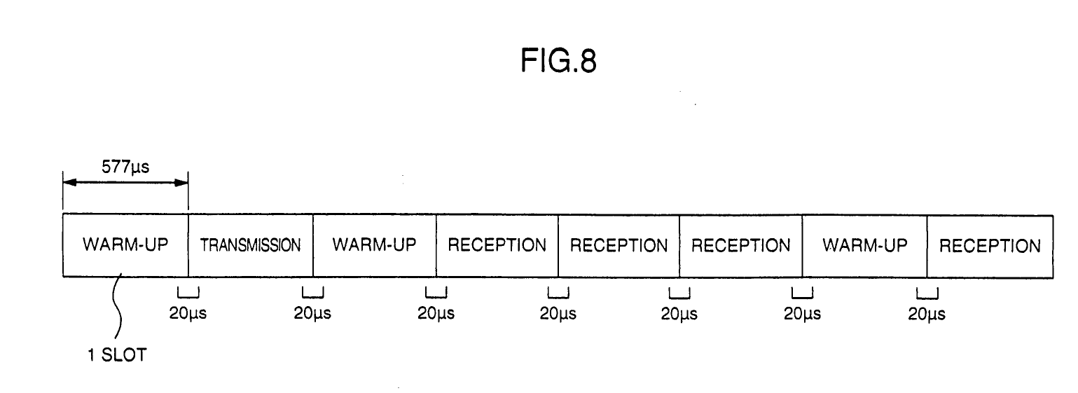

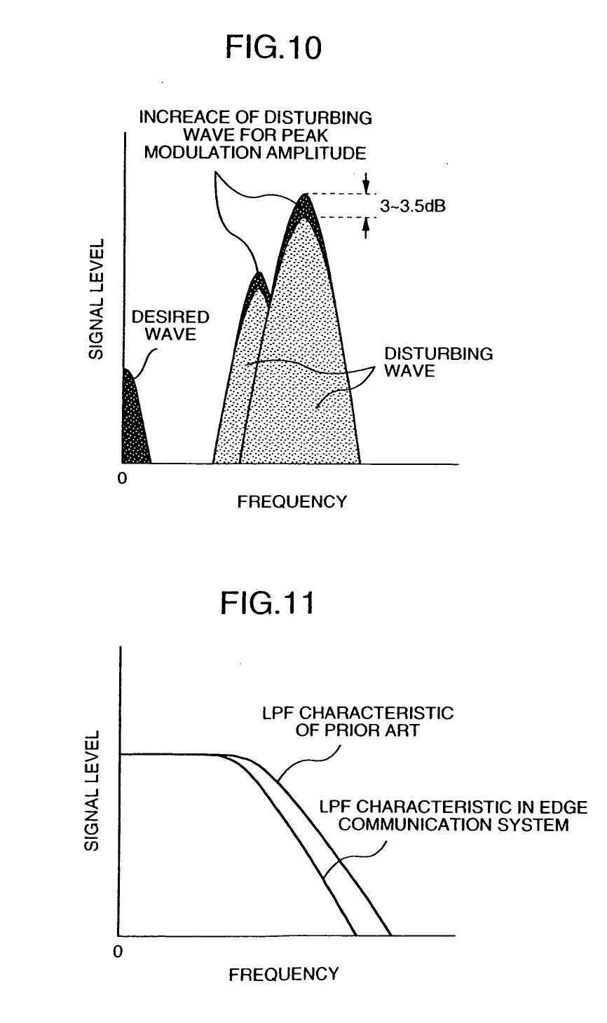

A portable telephone generally has, as shown in FIG. 7, a reception mode RMD, a transmission, mode TMD, an idle mode 1DM used, for example, in a wait state in which only some constituent components of the circuit operate and most constituent components thereof including at least the oscillator circuit 210 (and PGA circuit block 330) do not operate, namely, are in a sleep state, and a warm-up mode WMD in which, for example, the PLL circuit is activated. Under control of the system, a mode transition occurs via the warm-up mode in any case between the reception mode RMD, the transmission mode TMD, and the idle mode IDM. By conducting the offset cancel by the offset correction circuit OFC4 during the warm-up mode, the offset cancel of all amplifiers can be completely finished during the predetermined period of time.

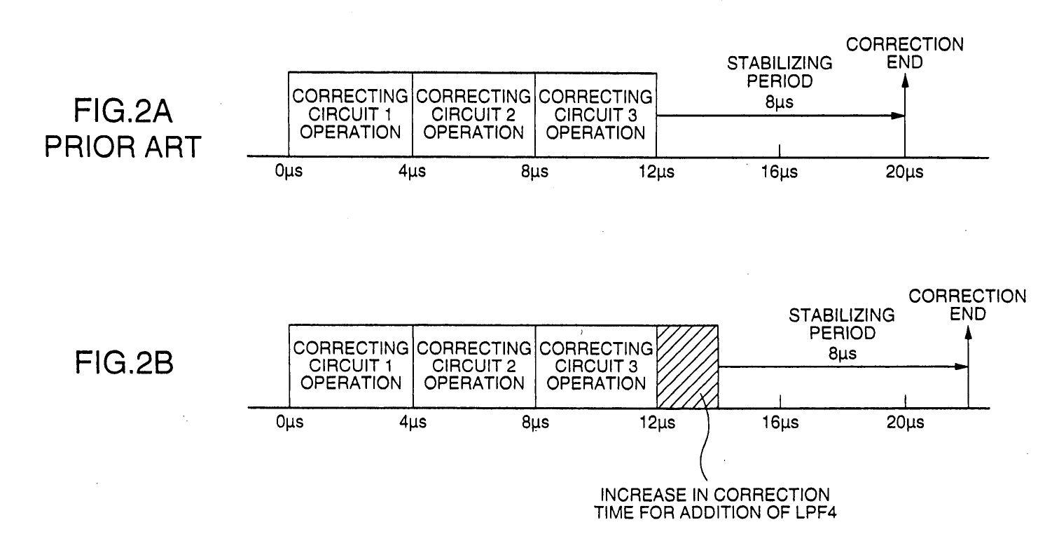

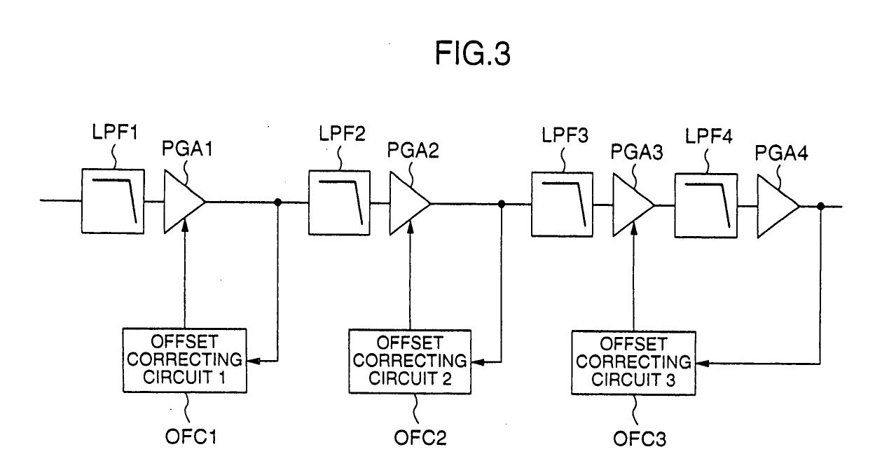

The programmable gain amplifiers PGA1 to PGA3 may be stopped during the offset cancel of the last amplifier FFGA. However, the circuit becomes complex in this case. Therefore, in this embodiment, with the amplifiers PGA1 to PGA3 kept powered, a short circuit is formed between the differential input terminals of the last amplifier FFGA to apply a predetermined potential via a capacity element thereto. The offset cancel is conducted for the programmable gain amplifiers PGA1 to PGA3 as shown in FIG. 2A. That is, in a state in which each amplifier is set to a gain determined by a base band according to a level of a signal received in a previous slot, the offset correction circuits OFC1 to OFC3 are sequentially operated, for example, each thereof is operated for 4 μs. After the circuits OFC1 to OFC3 finish the operation, there exists a stabilizing period of time of about 8 μs. When this period lapses, the operation is completely finished.

Although not particularly limited to, the control register CRG of the control circuit 340 includes three control bits TR, AC, and AM in this embodiment. According to a state of the bits, the control circuit 340 controls the circuits of the reception system. Table 1 shows a relationship between the control bits TR, AC, and AM of the control register CRG and internal states. The TR bit specifies “transmission or reception”, for example, “0” indicates “transmission” and “1” indicates “reception”. The AC bit specifies “offset cancel” of the programmable gain amplifiers PGA1 to PGA3, for example, “0” indicates the off state and “1” indicates the on state. The AM bit specifies the offset cancel of the last-stage programmable gain amplifier FFGA, for example, “0” indicates the off state and “1” indicates the on state.

TABLE 1

| TR | AC | AM | State |
|---|---|---|---|
| 0 | — | — | Warm up (transmission mode) |
| 1 | 0 | — | Warm up (reception mode; without |
| | | | offset correction) |
| 1 | 1 | 0 | Warm up (reception mode; with offset |
| | | | correction for PGA1 to PGA3) |
| 1 | 1 | 1 | Warm up (reception mode + offset |
| | | | correction for FFGA) |

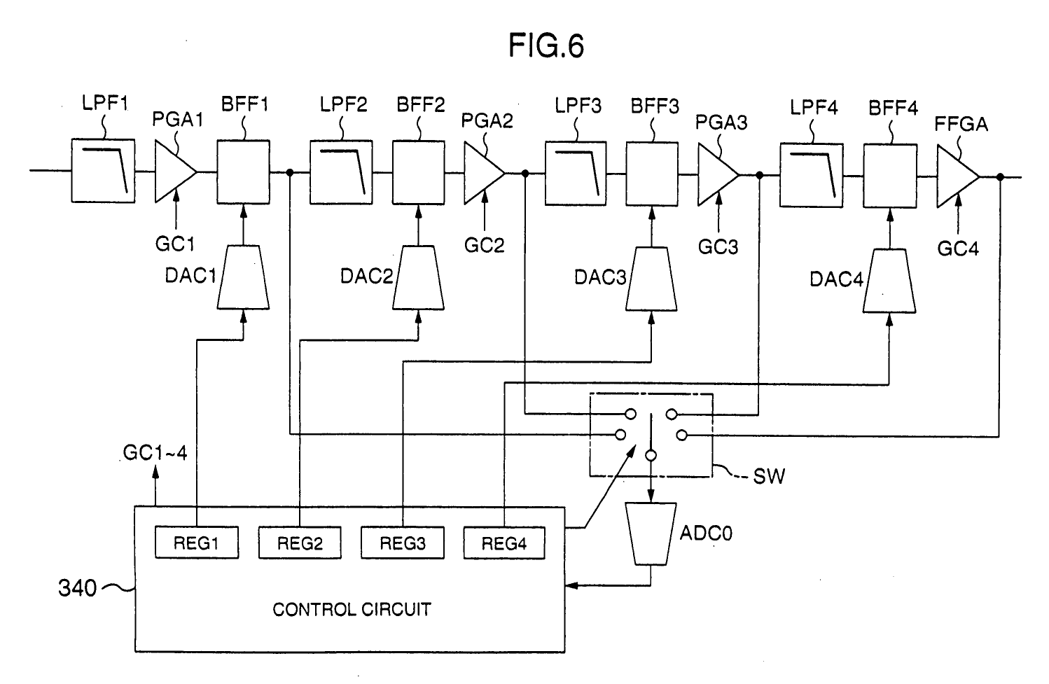

FIG. 6 shows another embodiment of the PGA circuit block 330.

This embodiment includes a switching circuit SW to operate an AD converter circuit ADC0 in a time sharing fashion between the offset correction circuits OFC1 to OFC4 respectively corresponding to the programmable gain amplifiers PGA1 to PGA3 and the last amplifier FFGA. In a respective one of buffer circuits BFF1 to BFF4 a current value flowing through a current source constituting each of the amplifiers PGA1 to PGA3 and FFGA is adjusted by a voltage obtained by converting the value held in an associated one of the registers REG1 to REG4 in the control circuit 340 respectively by associated one of the D/A converter circuits DAC1 to DAC4 so as to correct the offset of the amplifier. In FIG. 6, GC1 to GC4 indicate gain adjust signals and gain switch signals supplied from the control circuit 340 to the amplifiers PGA1 to PGA3 and FFGA.

The present invention of the inventor has been concretely described according to embodiments. However, the present invention is not restricted by the embodiments. In the embodiments described above, the PGA circuit block 330 includes, for example, three stages of programmable gain amplifiers. However, the programmable gain amplifiers are not limited to three stages, but may be configured in two stages or four stages or more.

In the description, the present invention of the inventor has been applied mainly to a high-frequency LSI used in an EDGE portable telephone in its background, i.e., the field of use thereof. However, the present invention is not limited to this field, but can be generally and broadly used for high-frequency semiconductor integrated circuits constituting a wireless communication system.

Advantages of the representative aspects of the present invention disclosed by this application will be described below.

That is, according to the present invention, since a filter circuit is disposed in a last stage of an amplifier circuit such as a PGA circuit block, the amount of attenuated waves in a high-frequency band can be increased without changing the passing band. The noise figure becomes better when compared with a case in which a filter circuit is arranged in a stage preceding a variable-gain amplifier. Moreover, since the last amplifier is an amplifier of which the gain can be changed, an optimal gain can be selected according to a type of a baseband circuit connected to the communication semiconductor integrated circuit (high-frequency LSI) and the general usability of the high-frequency LSI is expanded. By arranging a high-order filter circuit in a stage preceding the last amplifier, a satisfactory dynamic range can be obtained.

Furthermore, according to the present invention, also when a fixed-gain amplifier and a high-order low-pass filter are disposed in a last stage to amplify a received signal associated with amplitude modulation such as the EDGE modulation, the offset cancel operation can be completely finished by an offset correction circuit of the prior art within a predetermined period of time.

While the present invention has been described with reference to the particular illustrative embodiments, it is not to be restricted by those embodiments but only by the appended claims. It is to be appreciated that those skilled in the art can change or modify the embodiments without departing from the scope and spirit of the present invention.

1. A communication semiconductor integrated circuit device comprising an amplifier circuit, said amplifier circuit comprising:
a plurality of variable-gain amplifiers for amplifying a received signal and a plurality of filter circuits, said amplifiers and said filter circuits being connected to each other in a multi-stage configuration, wherein:
said amplifier circuit has an amplification factor variable according to a level of a received signal; and
said amplifier circuit comprises at the last stage thereof a last amplifier having a gain set regardless of the level of a received signal and a filter circuit.

2. A communication semiconductor integrated circuit device according to claim 1, wherein said last amplifier is an amplifier having a gain, the gain being changeable.

3. A communication semiconductor integrated circuit device according to claim 1, wherein said filter circuit at the last stage is disposed in a stage preceding said last amplifier.

4. A communication semiconductor integrated circuit device, comprising an amplifier circuit, said amplifier circuit comprising:
a plurality of variable-gain amplifiers for amplifying a received signal and a plurality of filter circuits, said amplifiers and said filter circuits being connected to each other in a multi-stage configuration; and
a last amplifier having a gain set regardless of the level of a received signal and a filter circuit, said last amplifier and said filter circuit being disposed at the last stage of said amplifier circuit,
said amplifier circuit having an amplification factor variable according to a level of a received signal, said communication semiconductor integrated circuit device further comprising:
a plurality of offset correction circuits for correcting direct-current offset, corresponding to said variable-gain amplifiers and said last amplifier, respectively,
the offset correction circuit corresponding to said last amplifier conducting an offset correction at a timing different from timing for the other offset correction circuits.

5. A communication semiconductor integrated circuit device according to claim 4, further comprising:
an oscillator circuit for generating a signal of a predetermined frequency, the generated signal being mixed with a received signal;
a first operation mode in which operation of at least said oscillator circuit is stopped;
a second operation mode in which said oscillator circuit is activated and stabilization of oscillation thereof is awaited;
a third operation mode in which a received signal is amplified and demodulated; and
a fourth operation mode in which a transmission signal is demodulated and amplified,
wherein, said offset correction circuit corresponding to said last amplifier conducts an offset correction in said second mode.

6. A communication semiconductor integrated circuit device according to claim 5, wherein:
said device sets said second, third, and fourth modes according to a predetermined time unit; and
said other offset correction circuits other than said offset correction circuit corresponding to said last amplifier conduct an offset correction during a period of time in which said predetermined time unit is changed.

7. A communication semiconductor integrated circuit device according to claim 5, further comprising:
a register for specifying said first to fourth operation modes; and
a control circuit for controlling the changing of said operation modes according to a setting of said register.

8. A communication semiconductor integrated circuit device according to claims 4, wherein said last amplifier is an amplifier having a gain, said gain being changeable.

9. A communication semiconductor integrated circuit device according to claims 4, wherein said received signal is a signal modulated in an Enhanced Data Rates for global system for mobile communications (GSM) Evolution (EDGE) mode.

10. A wireless communication system, comprising
a communication semiconductor integrated circuit device including an amplifier circuit,
said amplifier circuit comprising:
a plurality of variable-gain amplifiers for amplifying a received signal and a plurality of filter circuits, said amplifiers and said filter circuits being connected to each other in a multi-stage configuration,
a last amplifier having a changeable gain set regardless of a level of a received signal and a filter circuit, said last amplifier and said filter circuit being disposed at the last stage of said amplifier circuit, said amplifier circuit having an amplification factor variable according to a level of a received signal,
said communication semiconductor integrated circuit device further comprising,
a plurality of offset correction circuits for correcting direct-current offset, corresponding to said variable-gain amplifiers and said last amplifiers respectively, said offset correction circuit corresponding to said last amplifier conducting an offset correction at timing different from timing for the other offset correction circuits; and
a baseband circuit for extracting data from a received signal down-converted by said communication semiconductor integrated circuit device to a desired frequency and for converting transmission data into an I signal and a Q signal, wherein
timing of offset correction by said offset correction circuits, the gain of variable-gain amplifiers and said last amplifier are controlled according to a signal or data supplied from said baseband circuit.

11. A wireless communication system, wherein said communication semiconductor integrated circuit device comprises:
an oscillator circuit for generating a signal of a predetermined frequency, the generated signal being mixed with a received signal;
a first operation mode in which operation of at least said oscillator circuit is stopped;
a second operation mode in which said oscillator circuit is activated and stabilization of oscillation thereof is awaited;
a third operation mode in which a received signal is amplified and demodulated; and
a fourth operation mode in which a transmission signal is demodulated and amplified,
said offset correction circuit corresponding to said last amplifier conducting an offset correction in said second mode, said communication semiconductor integrated circuit device further comprising
a register for specifying said first to fourth operation modes, and
a control circuit for controlling the changing of said operation modes according to setting of said register,
said register being set according to data supplied from said baseband circuit.
